(19) United States
(12) Patent Application Publication
(10) Pub. No.: US 2004/0164847 A1
(43) Pub. Date: Aug. 26, 2004

(54) Secure unattended delivery system

(75) Inventor: John J. Hale, London (GB)

Correspondence Address: HITT GAINES P.C., P.O. BOX 832570, RICHARDSON, TX, 75083, US

(73) Assignee: BearBox, Com Ltd., London (GB)

(21) Appl. No.: 10/374,742

(22) Filed: Feb. 25, 2003

(51) Int. Cl. H04Q 1/00; G05B 19/00

(52) U.S. Cl. 340/5.73; 340/5.54; 340/5.28

(57) ABSTRACT

There is disclosed a secure storage unit for secure delivery of goods and a secure method for the delivery of such goods. In one embodiment, the secure storage unit is accessed by a two-part access code. In another embodiment, the secure storage unit is accessed by the use of an access code in a certain time frame. A central controller preferably controls the delivery technique. The technique is particularly advantageous when used as a method of delivering goods ordered over the Internet. The delivery technique is controlled through a central management system or hub, access to which may be provided through a website. Participating retailers can be accessed directly or through the central management system.

### CROSS-REFERENCE TO FOREIGN APPLICATION

This application claims the benefit of International Application No. PCT/GB01/03839 entitled “Secure Unattended Delivery System,” by BEARBOX LTD. et al., invented by John D. Hale, having an international filing date of Aug. 28, 2001, and a priority date of Aug. 25, 2000, which is incorporated herein by reference.

### TECHNICAL FIELD OF THE INVENTION

The present invention is directed, in general, to the delivery and collection of goods, and, more specifically, to the delivery of goods ordered using the Internet and a secure unit accessible by a owner for receiving such goods.

### TECHNICAL FIELD OF THE INVENTION

The use of the Internet for the purchase of goods is a rapidly growing area. Some of the main reasons why customers buy goods on-line over the Internet are convenience, price and speed. However, despite such advantages associated with buying goods over the Internet, the ‘final mile’ problems of delivering goods to the home deters some customers. This is because of the need to be at home on a particular day or at a particular time in order to receive the goods. Additionally, the process of returning goods to the supplier is also a problem which deters people from buying on-line.

In the current market, goods are typically delivered to customers at their home when someone simply happens to be at home when the goods are delivered or because the delivery company arranged with the customer for somebody to be at home at a specific time. Arranging for somebody to be at home at a specific time or arranging for goods to be left in another agreed place (for example, with a neighbor) compromises the convenience of home delivery. Additionally, the delivery company leaving goods on the property when nobody is at home to accept the delivery compromises security. Furthermore, the delivery of goods through a letter box compromises the choice of goods which can be delivered.

U.S. Pat. No. 5,774,053 to David Porter discloses a storage device that secures goods and provides a notification that goods have been delivered. The storage device is pre-programmed with a number of access codes that enable access to the storage device. Access codes, however, may be changed only by direct access at the storage device.

Accordingly, what is needed in the art is an improved method and system for delivering goods to or, obtaining collections from, a customer.

### SUMMARY OF THE INVENTION

To address the above-discussed deficiencies of the prior art, the present invention is directed to a secure unit for secure storage and a method of controlling access to the secure unit. In one embodiment, there is provided a storage unit for secure storage, the storage unit having a communications interface for communicating with a control management system. The storage unit receives an authorization access code including an authorized time slot from the control management system and enables access thereto responsive to use of the authorization access code in the authorized time slot at a user interface.

The present invention is particularly advantageous when applied to the delivery of goods ordered over the Internet. The present invention, however, also applies equally to goods ordered by, without limitation, telephone, fax, catalogue or from local suppliers.

In another aspect, the present invention provides a method of controlling a secure storage unit with the storage unit having a communications interface for communicating with a control management system. The method includes receiving an authorization access code, including an authorized time slot, from the control management system and enabling access to the storage unit responsive to the use of the authorization access code in the authorized time slot at a user interface.

In yet another aspect of the invention, there is provided a storage unit for secure storage, the storage unit having a communications interface for communicating with a control management system. The storage unit is provided with a bar-code representing at least a part of an authorization access code and enables access thereto responsive to use of the authorization access code at a user interface.

In this aspect, there is also provided a method of controlling access to a secure storage unit comprising providing a bar-coded display representing at least a part of an authorization access code. The method further enables access to the secure storage unit responsive to use of the authorization access code at a user interface.

In accordance with yet another aspect of the present invention, there is provided a portable communications device having a communications interface for communicating with a storage unit. The storage unit enables access thereto responsive to an authorization access code. The portable communication device provides at least part of the authorization access code.

In this aspect, there is also provided a method of controlling access to a secure storage unit comprising providing a portable communications device having a communications interface for communicating with the storage unit. The storage unit enables access thereto responsive to an authorization access code, wherein the portable communication device transmits at least part of the authorization access code.

In accordance with yet another aspect of the present invention, there is provided a controller for a delivery system including means for receiving notification of an order for goods, means for communicating details of the order to a delivery carrier and means for communicating with a secure storage unit. Responsive to receipt of notification of an order, an authorization code to enable access to the secure storage unit is transmitted to the delivery carrier and the secure storage unit. The authorization code includes an authorized time-slot for use of the authorization code.

In this aspect, there is also provided a method of controlling a delivery system including receiving notification of an order for goods from a customer, communicating details of the order to a delivery service. The step of communicating details to the delivery service includes providing the delivery service and the delivery unit with an authorization code to enable access to the delivery unit. The authorization code includes an authorized time-slot.

In accordance with yet another aspect of the present invention, there is provided a storage unit for secure storage. The storage unit includes a communications interface for communicating with a control management system and receives an authorization access code having at least two parts from the control management system. The storage unit enables access thereto responsive to use of the authorization access code in the authorized time slot at a user interface.

In this aspect, there is also provided a method of controlling a secure storage unit, the storage unit having a communications interface for communicating with a control management system. The method includes receiving an authorization access code having at least two parts from the control management system and enabling access to the storage unit responsive to the use of the authorization access code in the authorized time slot at a user interface.

In accordance with yet a further aspect of the invention, there is provided a portal for providing access to a set of retailers each being associated with a secure control or delivery management system. The secure control management system controls a delivery to a secure storage unit by receiving notification of an order for goods from a customer and communicating details of the order of a delivery service. The step of communicating details to the delivery service includes providing the delivery unit with an authorization code to enable access to the delivery unit. The system also makes the authorization access code available to the delivery service, the authorization code including an authorized time slot. The portal preferable comprises a website and the authorization access code is preferably made available to the delivery service via the portal.

In a still further aspect, there is provided a portal (e.g., a website) for providing access to a set of retailers each being associated with a secure delivery system utilizing a secure storage unit. The storage unit includes a communications interface for communicating with a control or delivery management system. The operation of the secure delivery system includes receiving an authorization access code, including an authorized time slot, from the control management system at the storage unit and enabling access to the storage unit responsive to the use of the authorization access code in the authorized time slot at a user interface of the storage unit.

### BRIEF DESCRIPTION OF THE DRAWINGS

For a more complete understanding of the present invention, reference is now made to the following descriptions taken in conjunction with the accompanying drawings, in which:

FIG. 1 illustrates block diagram of an embodiment of a delivery system constructed in accordance with the present invention;

FIG. 2 illustrates a block diagram of an embodiment of main control elements of a secure storage unit constructed in accordance with the present invention;

FIG. 3 illustrates a block diagram of an embodiment of main elements of each of block shown in FIG. 1; and

FIGS. 4(a) to 4(j) illustrate flow diagrams illustrating functionality of embodiments of a secure box constructed according to the principles of the present invention.

### DETAILED DESCRIPTION

In the following description, where reference is made to customers or retailers, these references are interchangeable with receivers and senders of goods, which can include all kinds of deliveries including business documents or deliveries to or from collections from business premises.

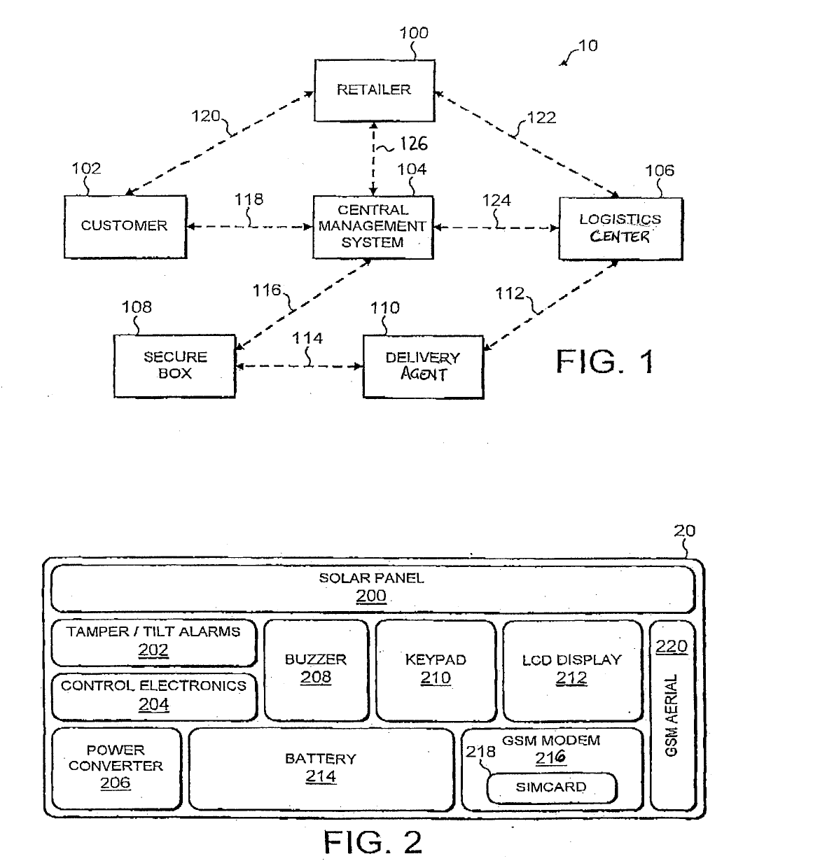

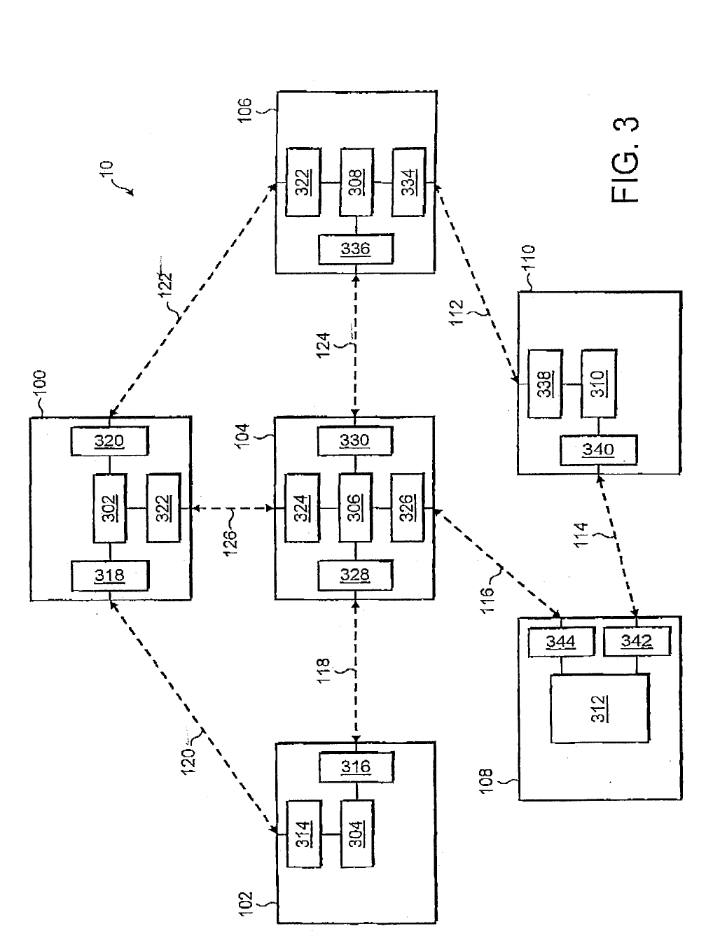

Referring initially to FIG. 1, there is generally illustrated in block diagram form exemplary elements of an embodiment of a delivery system 10 according to the present invention. The delivery system 10 includes a retailer 100, a customer 102, a central management system 104, a logistics center 106, a secure box or storage unit 108 and a carrier or delivery agent 110 associated with the logistics center 106. The central management system 104 may be used to control the delivery system 10. In FIG. 3, the elements of FIG. 1 are also illustrated with main functional elements identified.

In accordance with a preferred embodiment of the present invention, the central management system 104 of the invention is a BearBox central management system provided as a separately managed entity to the retailer 100 and the logistics center 106. The central management system 104 is advantageously implemented on a server. However, it will be apparent from reading the following description of this embodiment that the central management system 104, the retailer 100, and the logistic center 106 may be operated as a single system, for example, under the operation of a single company.

In the preferred embodiment, the customer 102 is assumed to be located at their home. The customer 102 acquires an account with the central management system 104. The preferable way in which the customer 102 acquires an account with the central management system 104 is by purchasing a secure box 108. Purchasing a secure box 108 automatically gives the customer an account. In the example, the secure box 108 is a BearBox secure box and the customer 102 is provided with a BearBox account on purchase thereof.

Other options for acquiring an account with the central management system 104 may exist. For example, after purchasing a secure box 108, the customer 102 may telephone the company in charge of the central management system 104 to obtain an account. In a further alternative, the customer 102 may log-on to a website associated with the central management system 104 in order to register for an account. Once the account is registered, the customer 102 is provided with an account number for future use.

The intercommunication between the customer 102 and the central management system 104 is represented by communication line 118, and in this described embodiment is implemented over the Internet. As illustrated in FIG. 3, the customer preferably has a computer terminal 314 having a communication interface for communicating with the retailer via communication line 120, and a communication interface 316 for communicating with the central management system 104 via communication line 118. One skilled in the art will understand that a line representing a common line as used throughout the specification may represent several lines (i.e., several common lines).

The customer 102 may log onto a website provided by the retailer 100 for the purpose of ordering goods from the retailer 100. In one example, it is assumed that the retailer 100 is integrated into the central management system 104. Therefore, when the customer 102 orders goods on the website of the retailer 100, the order form will include a request for the customer 102 to enter an account number (e.g., a BearBox account number). In the event that a customer 102 does not have an account and leaves the account number field blank, then the order will be processed and delivered in another conventional way.

In a particularly advantageous embodiment of the present invention, a customer 102 having an account with the central management system 104 logs onto a website (e.g., a BearBox website) associated with the central management system 104. This website then has links to retailers who use the delivery system 10 associated with the central management system 104. In this way, customers who order goods over the Internet may have direct access to retailers who use the delivery system 10 controlled by the central management system 104.

The website may also provide other features. For example, the website may provide means for the customer to change their password (which provides secure access to the website). A security box (e.g., a BearBox security box) may also be purchased using the website.

Once the customer 102 has placed an order with the retailer 100 requesting delivery, the retailer 100 communicates with the central management system 104 via communication line 126. The communication line 126 is preferably provided via the Internet. During this communication, the central management system 104 provides the retailer 100 with an authorization code to be used during the remainder of the delivery process. As illustrated in FIG. 3, a computer terminal or computer 302 of the retailer 100 is connected to the communication line 126 via a communications interface 322. A computer terminal 306 or processor of the central management system 104 is connected to the communication line 126 via a communications interface 324.

That is, the central management system 104 receives a message electronically from the retailer 100. In practice, this message will be received from a computer system associated with the retailer 100. Responsive to such message, the central management system 104 transmits messages electronically to the computer system of the retailer 100.

Thereafter, the retailer 100 communicates with the logistic center 106 via communication line 122, again, preferably provided via the Internet. The computer 302 may provide communication between the retailer 100 and the logistics center 106 by means of electronic messages exchanged between their respective computer systems.

Thereafter, the logistic center 106 communicates with the central management system 104 via communication link 124, again, preferably provided via the Internet. A computer 308 of the logistics center 106 and the computer 306 of the central management system 104 are connected to communication line 124 via communication interfaces 336, 330, respectively.

The logistic center 106 uses the authorization code provided by the retailer 100 to initiate communication with the central management system 104. In response to a valid authorization code, the central management system 104 communicates with the logistic center 106 to confirm delivery details, including providing an authorization code or access code. The communication between the logistics center 106 and the central management system 104 may again be by means of electronic messages.

The authorization code is effectively a sequential number, issued each time the retailer makes a new booking, and is used primarily for reference and as a means of searching for a particular booking's details. The access code or authorization access code is the code that opens the secure box 108 when typed in at a keypad interface, or simply a keypad, or entered by other means. The retailer 100 passes the authorization code to the delivery agent 110.

In confirming delivery details, the central management system 104 communicates with the secure box 108 via communication link 116 to establish that the secure box 108 is fully functional and that it is available to accept delivery. The availability of delivery may be determined by, for example, deliveries already arranged to be made to the secure box 108 which would result in the secure box 108 being full at particular times.

The computer 306 of the central management system 104 and a controller 312 of the secure box 108 are connected to communication line 116 via communication interfaces 326, 344, respectively. As will be discussed in further detail herein below, the communication link 116 is preferably a wireless link. The communication between the central management system 104 and the secure box 108 is by exchange of electronic messages, as will be described in further detail hereinafter.

Once the central management system 104 has established the functionality and availability of the secure box 108, then it communicates with the logistics center 106 to arrange an appropriate delivery slot. Preferably, the delivery slot will be limited to a particular time window. That is, the logistic center 106 will be provided with a particular time window or date window for making delivery to the secure box 108.

In addition, the central management system 104 will provide the logistic center 106 with an access code or authorization access code for the secure box 108. The central management system 104 will then communicate the access code or authorization access code provided to the logistic center 106 to the secure box 108, together with the details of any date or time window allocated to the logistic center 106 and associated with the access code.

In an alternative arrangement, the logistic center 106 may not receive the access code from the central management system 104. In this alternative arrangement, the logistic center 106 obtains the access code by accessing the website, using a password or other secure means, to retrieve the access code for the delivery.

Thereafter, the logistic center 106 provides details of the authorization code for access to the secure box 108 to the delivery agent 110, preferably either a delivery van or delivery person, via communication link 112, which may be a wireless link. The computer 308 of the logistics center 106 and a controller 310 of the delivery agent 110 are connected to communication link 112 via communication interfaces 334, 338, respectively.

The delivery agent 110 will of course also carry the goods for delivery. The delivery agent 110 will also be provided with the date and time window for which the authorization code is valid. In this way the logistics center 106, when arranging and agreeing on the delivery window with central management system 104, may be able to arrange for deliveries in a particular geographical area to be made on the same day or within the same time window. This may make use of delivery agent 110 by the logistics center 106 much more efficient and dramatically reduce the number of failed deliveries.

The delivery agent 110 then delivers the goods for delivery to the secure box 108 within the time window, using the authorization code. The details of the secure box 108 are described in further detail hereinbelow with respect to FIG. 2, but in this embodiment the secure box 108 is provided with a keypad for entry of the authorization code. When the authorization code is entered in the secure box 108 by the delivery agent 110, a signal is communicated to the central management system 104 via communication link 116 to indicate that the delivery has been made. In response to such signal, the central management system 104 may communicate the successful delivery to any of the customer 102, the retailer 100 and the logistics center 106.

The central management system 104 is, as discussed herein above, preferably associated with a website (e.g., the BearBox website). The website may additionally provide means for the customer 102, the retailer 100, or the logistics center 106 to monitor an order of goods and the progress of delivery. As discussed above, the website associated with the central management system 104 may provide an e-commerce portal to the websites of retailers, such as retailer 100, using the central management system 104 to organize deliveries. In such a way, customers having an account with the central management system 104 and wishing to order delivery of goods where a particular delivery procedure such as the BearBox delivery procedure can be applied, will be able to access the retailers supporting the delivery system 10 through the website of the central management system 104.

The secure box 108 is a box for depositing goods delivered to the premises of the customer 102, such as a private house, when the customer 102 is absent. Access to the secure box 108 will be available to the customer 102 at any time by means of a key. It is envisaged in certain embodiments that the customer 102 may have a master access code for accessing the secure box 108. As discussed herein above, access to all others, such the as delivery agent 110, will be limited by means of a time windowed access code.

The implementation of the secure box 108 in accordance with a preferred embodiment of the invention will now be described further with reference to a control unit 20 illustrated in FIG. 2. The control unit 20 for the secure box 108 includes a solar panel 200, tamper/tilt alarms 202, control electronics 204, a power converter 206, a buzzer 208, a keypad 210, a liquid crystal display (LCD) 212, a battery 214, a Global System for Mobile Communications (GSM) modem 216 including a slot for a Subscriber Identity Module (SIM) card 218 and a GSM aerial 220.

The GSM modem 216 is preferably a dual band 900/1800 with the SIM card 218 connected to the internal GSM aerial 220. The SIM card 218 may be a “pay as you go” SIM card. In this way the secure box 108 can communicate with the central management system 104 via a wireless link providing the communication link 116. Although the GSM modem 216 is used in this preferred embodiment, other wireless technology may be provided for communicating on the communication link 116, for example, Universal Mobile Telecommunications System (UMTS) technology or Bluetooth technology.

The solar panel 200 is intended to provide power to the various electronic elements and also to charge the battery 214. The dimensions of the solar panel 200 are chosen to suit the power requirements of the control unit 20 and the recharge parameters of the battery 214. In the preferable embodiment, the solar panel 200 is dimensioned to provide sufficient power based on one hour of direct sunlight in every 24 hours. The battery 214 itself is selected to suit power requirements for a maximum daily usage based on estimated figures. A facility for external recharging may be supplied to charge new or abused batteries or to accept local power if suitable and available without compromise to the security of the system. The power converter 206 is preferably provided to convert the power from the solar cell 200 or from an external charger to charge the battery 214. In an alternative embodiment, the control unit 20 may be powered directly from a main power supply.

The control electronics 204 in the preferred embodiment is a microprocessor based card containing non-volatile memory, a real time clock, a tamper monitor, a GSM modem interface, LCD drivers, a microphone and speaker drives, deadlock controls, and configuration control software for the control unit 20. The implementation of such control electronics will be well within the scope of someone skilled in the art.

The LCD 212 will preferably be a small display mounted in a prominent position on the outside of the secure box 108. The buzzer 208 is preferably provided to provide a small audible warning device to signal, for example, menu selection confirmations and to detect alarm conditions.

The keypad 210 is used to obtain access to the secure box 108 by both the customer 102 and the delivery agent 110 and, preferably, also to enter information as will be described further hereinbelow for communications to the central management system 104. The keypad 210 and the LCD 212 will be used in tandem, with the LCD 212 providing prompts for the information to be entered via the keypad 210. In addition a light emitting diode (LED) backlight may be added to the LCD 212 to enable viewing at night.

The design of the detailed mechanical aspects of the secure box 108 is not discussed herein. The size of the secure box 108 may vary according to different applications and a customer 102 may be able to choose different sizes of secure box 108 to be fitted at their preferred location. In a preferred implementation, it is intended that the secure box 108 will be of a size to take two crates of wine or beer or a household weekly shop. The basic model of the secure box 108 will be a single box with an opening lid or side.

The solar panel 200 discussed herein above will preferably be positioned in the lid of the secure box 108. The solar panel 200 will either be mounted behind a toughened plastic panel or be of a toughened glass construction. The LCD 212 and keypad 210 are also mounted in a prominent position on the outside of the secure box 108. The design of the secure box 108 is such that damage to the solar panel 200, keypad 210, or LCD 212 will not enable access to the interior of the secure box 108. In a preferable embodiment, the secure box 108 is provided with a mechanical override key activated lock which will allow access to the secure box 108 in case of a electronic circuitry failure for whatever reason.

The secure box 108 may also be provided with means for fixing removable panels thereto. In this way, an owner of a secure box 108 can choose a style of paneling, which perhaps best suits the environment in which the secure box 108 is located, and change the appearance of the secure box 108.

Access to the secure box 108 can be made by the owner at any time by means of a mechanical key or by entering a personal identification number (PIN) number via the local keypad 210 located on the secure box 108. Access to the secure box 108 can also be made by the delivery agent 110 by entering their unique time-windowed keycode via the keypad 210. In an alternative embodiment described further hereinbelow, the delivery agent 110 may be able to access the secure box 108 using a wireless link between the secure box 108 and a portable unit carried by the delivery agent 110. The keycode, and the associated time window, is downloaded by the central management system 104 directly to the secure box 108 via link of the GSM modem 210. The keycode is preferably encrypted by the central management system 104 before downloading. Once access to the secure box 108 is gained, a confirmation status message will be uploaded to the central management system 104.

Various alternative implementations of the control of the secure box 108 will now be described. There are various modes of operation in which access to the secure box 108 may be provided. These modes will now be described and it should be apparent to one skilled in the art that various combinations of these modes may also be used.

In a first mode, the authorization access code is transmitted from the central management system 104 to the secure box 108 and the logistics center 106. A communications interface 342 of the secure box 108 comprises a user interface incorporating an alphanumeric keypad. The alphanumeric keypad may be any one of a number of designs and may alternatively be only a numeric keypad or only an alphabetic keypad.

The delivery agent 110 is provided with the authorization access code by the logistics center 106. The delivery agent 110 may physically obtain the authorization access code from the logistics center 106. In a preferred embodiment, the logistics center 106 transmits the authorization code via the communications interface 334 on the communication link 112 to the delivery agent 110, which receives the code at the communication interface 338. The processor 310 and the communication interface 338 may be provided in a van or in a portable device carried by the delivery agent 110. The processor 310 is also associated with a display for displaying the authorization access code received at the communication interface 338. The authorization access code preferably includes an authorized time window within which the code may be used, which is also displayed to the delivery agent 110. In this mode of operation, the delivery agent 110 then enters the authorization access code in the keypad of the user interface of the communications interface 342, to thereby gain access to the secure box 108.

In a further mode, the goods which are being delivered may have a goods authorization code associated therewith which forms part of the access code required to access the secure box 108. In this mode, the delivery agent 110 may receive a first part of the authorization access code, which may be termed a carrier authorization code, as described above. The second part of the authorization access code, associated with the goods, is needed as well in order to gain access to the secure box 108. The goods authorization access code may be provided on the goods themselves or on paperwork associated with goods. The goods authorization code may be provided in encoded form, such as a bar-code display. In this case, the delivery agent 110 is provided with a bar-code scanner to read the bar-code and display the goods authorization code. Where the delivery agent 110 is provided with a portable device for receiving a part of the authorization access code from the logistics center 106, the same portable device may incorporate the bar-code scanner.

Where two such parts of the access authorization code are provided, access to the secure box 108 may be provided by a simple combination of the two parts. For example, the delivery agent 110 may be issued with a six digit code and the goods to be delivered may be associated with a four digit code. Combining the two into a ten digit code gives the authorization access code. Alternative arrangements may exist. For example, it may be better to first enter the carrier authorization code and, if this is accepted, then enter the goods authorization code.

In a further mode of operation, the user interface of the communications interface 342 of the secure box 108 may include a communications interface for communicating with a remote device, either in conjunction with or in place of the keypad. The remote device may be a portable device carried by the delivery agent 110 and, instead of entering the authorization access code via the keypad, the delivery agent 110 may simply enter an authorization access code stored directly in the portable device via a remote communication link.

For example, if the logistics center 106 transmits an authorization code to the delivery agent 110 having a portable device, the authorization code is merely stored in a memory associated with the processor 310. The delivery agent 110 then accesses the secure box 108 by communicating the authorization code via the communications interface 340 to the communication link 114, which is received by the communication interface 342 of the secure box 108. The communication link 114 may be any type of remote or wireless link. Examples are an infra-red link or a Bluetooth link. In a further mode of operation, access to the secure box 108 may be enabled responsive to a combination of the remote link and the keypad.

In a further mode of operation, a bar-code display may be provided on the outside of the secure box 108. The delivery agent 110, having a portable device including a bar-code scanner, may then scan the bar-code to retrieve at least a part of the authorization access code. This part of the authorization access code may be used in combination with any part described hereinabove to access the secure box 108, either using the keypad or the remote link to the portable device.

In different mode of operation, the authorization access code may be provided solely in the form of a bar-code display on the outside of the secure box 108. The delivery agent 110 scans the bar-code using a portable device to retrieve the full authorization access code, the authorization access code then being entered at the user interface using either the keypad or the remote link. In this mode, as discussed above, such a bar-code display may only represent part of the authorization access code.

In this mode, the authorization access code provided by the bar-code display on the secure box 108 can be considered to be a box authorization code and may be equivalent to the carrier authorization code. The full access authorization code is then obtained from scanning the goods authorization code provided on the goods for delivery. The box authorization code will be fixed, because of the nature of the bar-code display, but the goods authorization code will vary. Thus, the central management system 104 will transmit at least the goods authorization code part of the authorization access code to the secure box 108. From the above description, it will be apparent that many different combinations exist and the skilled reader will be able to derive from the above combinations other than those described.

As mentioned above, the invention has been described from the perspective of the delivery of goods. The invention may also operate for the customer 102 to return goods. In this arrangement, the goods are left in the secure box 108 by the customer 102 and either the retailer or the central management system 104 is notified. The delivery agent 110 may then access the secure box 108 in exactly the same manner to retrieve the goods. Obviously in this case, no goods authorization access code can be provided on the goods themselves, but it may be provided to the delivery agent 110 on paperwork associated with the return of the goods. The technique of providing an authorization access code with at least two parts (for example, with a carrier authorization code and a goods authorization code) is particularly advantageous in ensuring secure delivery.

Instructions for using the secure box 108 are preferably displayed on the LCD 212, which preferably has a simple to use English language menu of commands and messages, for example “enter PIN number,” “wrong PIN number please re-enter,” etc. The precise layout of the menu structure is a matter of design choice.

As indicated by the tamper/tilt alarms 202 in FIG. 2, the secure box 108 is preferably provided with electronics to detect unauthorized tampering. If a tamper is detected by means of a movement and tamper switch arrangement, then an emergency call or alarm is established to the central management system 104 and, if necessary, action taken.

Preferably, the secure box 108 additionally monitors the condition of the internal battery 214 and establishes an emergency or alarm call to the central management system 104 in the event of the battery level falling below a certain level. The battery level at which such alarm is triggered is linked to the time of day, such that a shorter battery life is acceptable in the morning (when power will be provided by the solar panel) but a much longer battery life will be necessary in the evening time.

The keypad 210 may also be used by the delivery agent 110 to enter information as to the status of the secure box 108. After making the delivery to the secure box 108, the delivery agent 110 may be prompted by the LCD 212 to provide information on the status of the secure box 108. For example, the LCD 212 may prompt the delivery agent 110 to enter information as to whether the secure box 108 is now full, empty, or half-full. After the delivery is made, the LCD 212 may also provide a confirmation code to the delivery agent 110, which is also communicated to the central management system 104.

In a further preferable embodiment, a bar code may be incorporated into the inside of the secure box 108. The bar code may be scanned by a handheld device carried by the delivery agent 110 which will act as proof of delivery for the delivery agent 110.

The central management system 104 is preferably able to download status information from the secure box 108 at any time. The status information may include the battery level and whether goods have been delivered to the secure box 108 including identity of the goods delivered by virtue of the authorization code used by the delivery agent 110.

The central management system 104 may, in addition, periodically set and update the real time clock in the secure box 108. Whenever the secure box 108 is opened, a time stamp and status message will be automatically transmitted to the central management system 104, including an identification of the means (access code or key) used to open the secure box 108.

In the preferable embodiment, the communication between the secure box 108 and the central management system 104 using the GSM link utilizes Short Messaging Service (SMS) messages. The SMS messages will allow for the following communications:

1. Update time from server to the secure box 108.

2. Update validation PIN number. This defines a PIN number and a start time/date and stop time/date for the validation window. The number of separate PIN numbers and time windows which can be stored in the secure box 108 is variable dependent upon the implementation of the electronics therein. Expired PIN numbers are deleted automatically and an appropriate message sent back to the central management system 104.

3. Request status from the secure box 108.

4. Status from the secure box 108. This defines any current alarms, for example, tamper alarm, battery low alarm or illegal PIN entry alarm. This message preferably also senses the current secure box 108 status of empty, half full or full.

5. Box delivery has been made. This message is sent each time the secure box 108 is opened and also contains the status information as defined in 4.

An example implementation in the central management system 104 and the secure box 108, conforming to the SMS protocol is as follows:

Poll From Server to Box:

1) Set PIN and time validation window

DD.MM.YY.hh.mm.ss: PIN=XXXXXXXX: ON=DD.MM.YY.hh.mm.ss: OFF=DD.MM.YY.hh.mm.ss:

2) Request status

DD.MM.YY.hh.mm.ss RS

Poll From Box to Server:

Time Stamp: Current Status: Expired PIN

DD.MM.YY.hh.mm.ss: B=x: C=y: O=n: T=z: L=v: E=XXXXXXXX

B=Battery Low alarm (=1 battery=low,=0 battery OK)

T=Tamper alarm (=1 tamper active, =0 no tamper)

O=Opened (=1 Box lid accessed, =0=No access)

L=Box lid not closed timeout expired (=l=Box lid open alarm, =0=box lid closed OK)

C=Box Condition (=3=Full,=2=Half Full,=1=Empty)

E=Expired PIN Number time window has elapsed without entry. (=0=no expired PINs, or =Pin No)

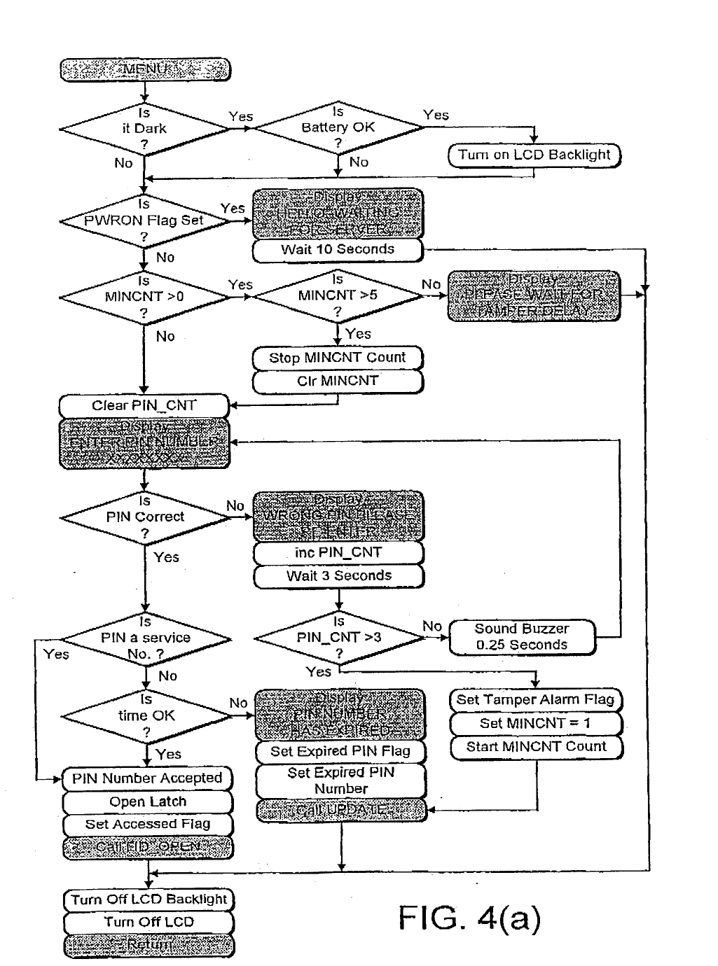

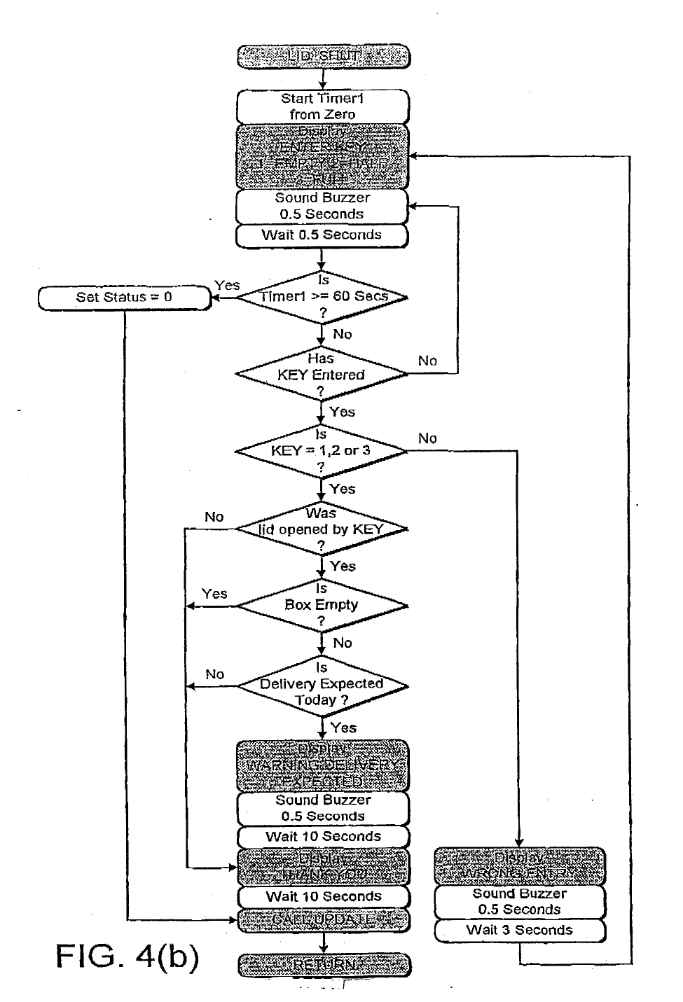

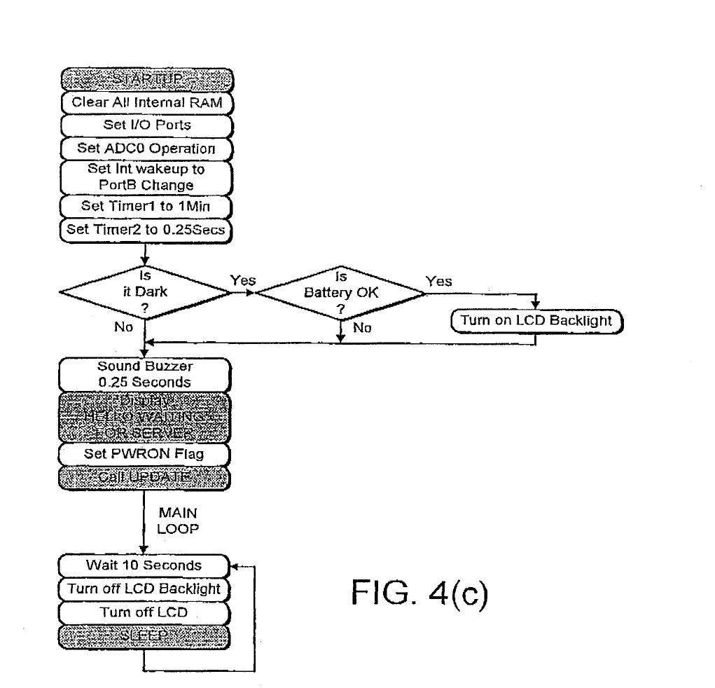

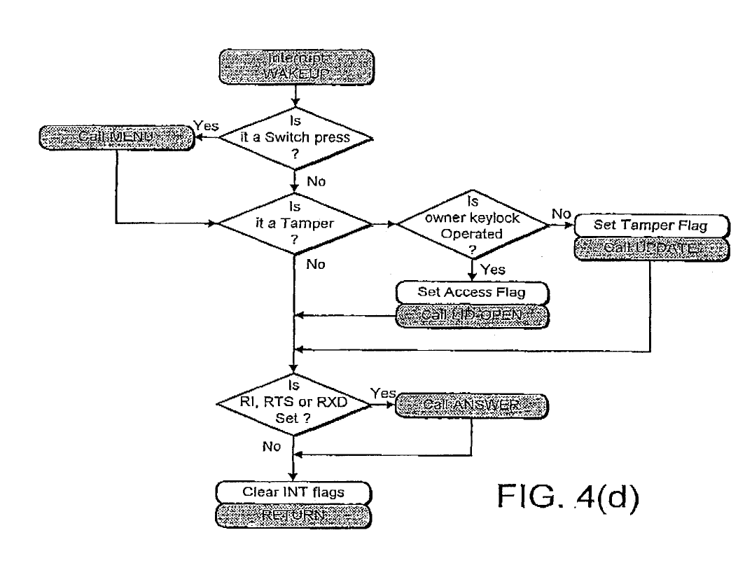

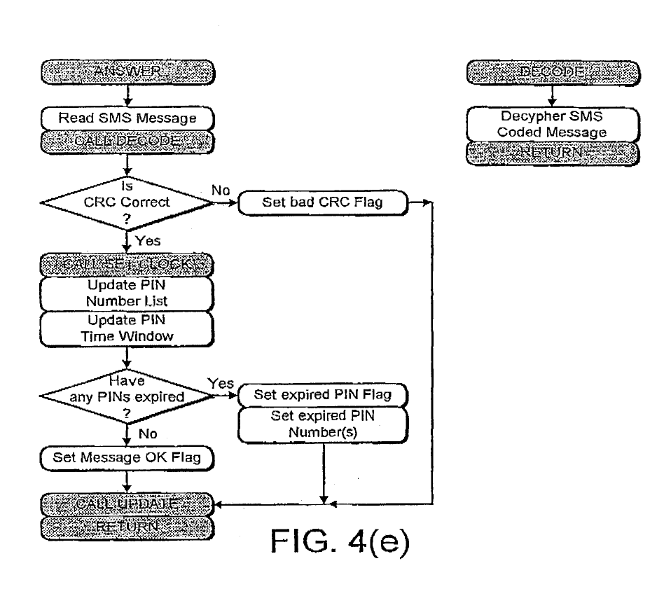

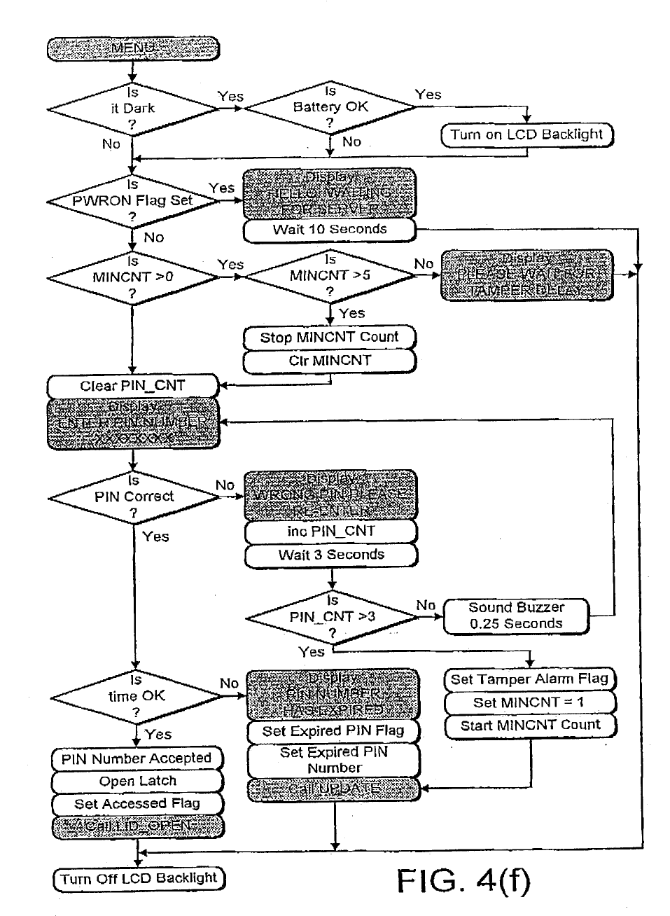

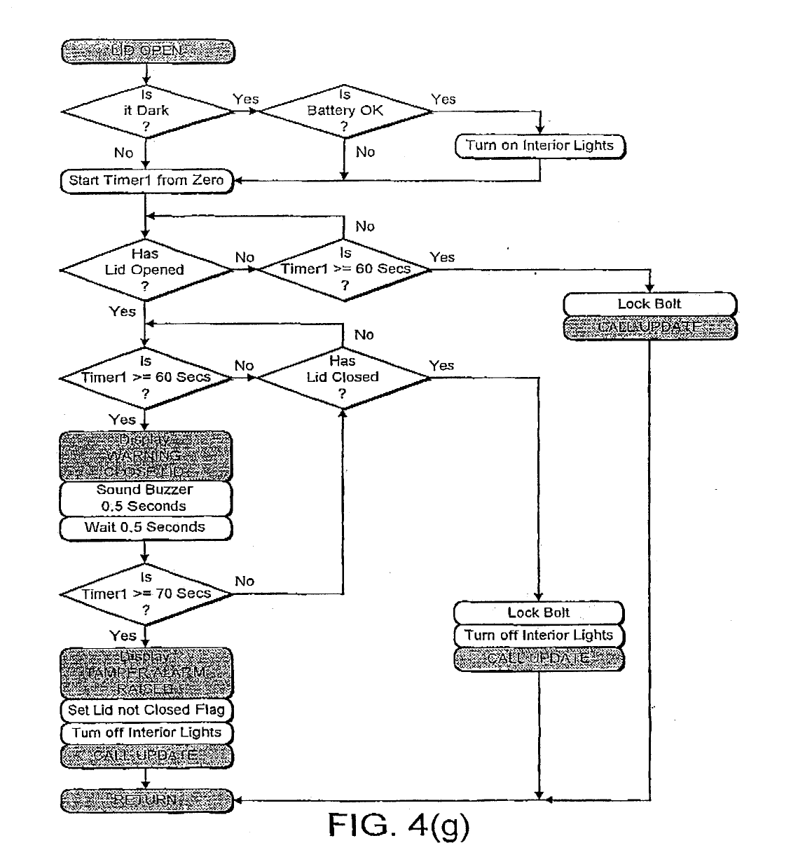

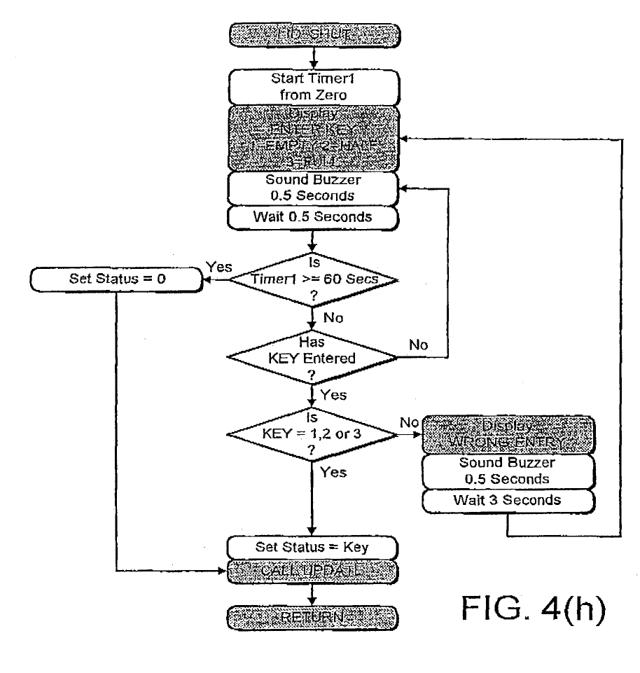

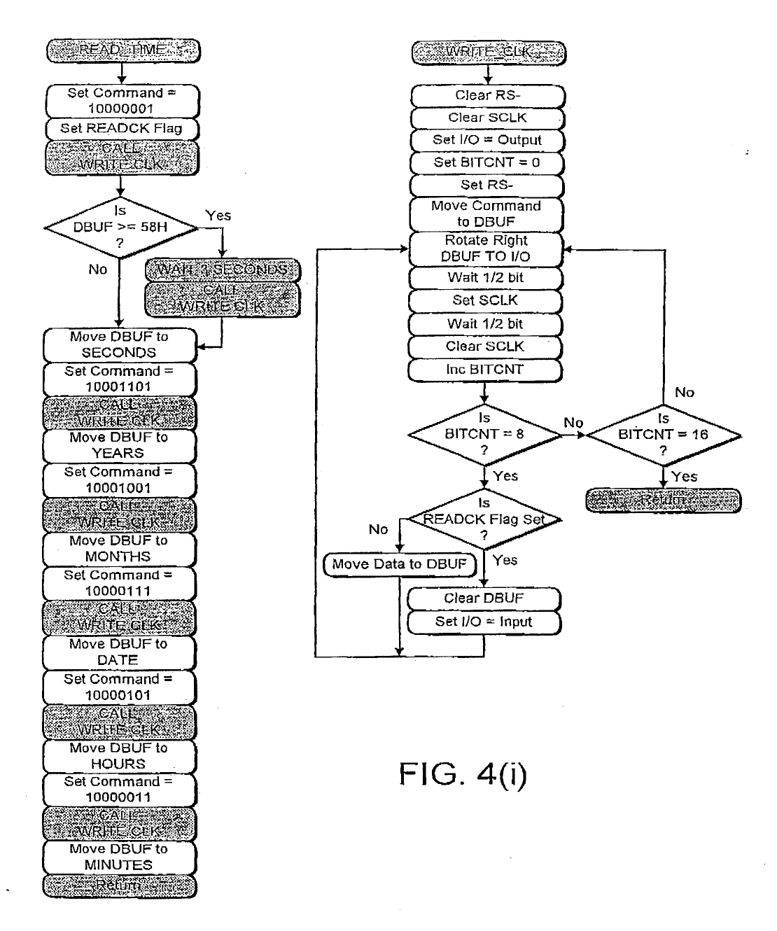

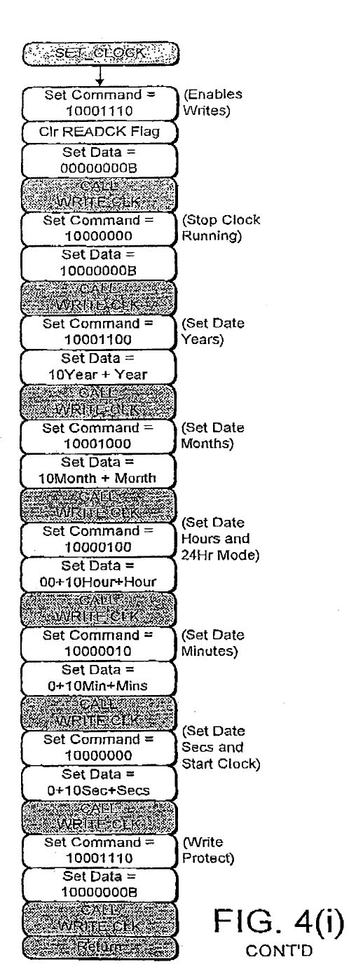

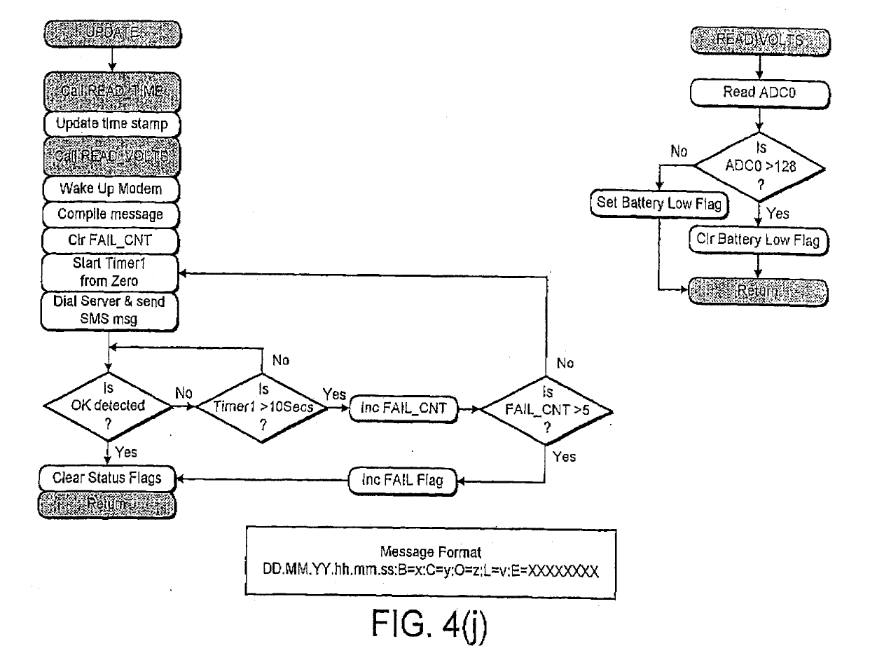

FIGS. 4(a) to 4(j) show various flow diagrams representing the operation of the control electronics 204 of the secure box 108 and the user interface of the communications interface 342 thereof.

In a preferred embodiment, the website provides a hub for the functionality of the delivery system 10. The parties involved—the retailer 100, the delivery agent 110 and the customer 102—can access the status of deliveries through the website using appropriate passwords. In addition, the delivery agent 110 may preferably retrieve the authorization code, or a part thereof, for making the delivery from the website. The website preferably provides an e-commerce portal to all participating retailers supporting the delivery system 10. Thus, customers can be confident that all retailers accessed through the website provide the secure delivery system 10 unique to the system such as a BearBox system.

The secure box 108 itself, the control of which is preferably integrated into the website, may be adapted according to a particular customer's needs and various models may be available. The secure box 108 may incorporate refrigeration means, either solid-state or conventional or both. Retailers and/or delivery carriers may be provided with special thermal packaging for keeping products cool or warm for extended periods.

Although the present invention has been described in detail, those skilled in the art should understand that they can make various changes, substitutions and alterations herein without departing from the spirit and scope of the invention in its broadest form.

What is claimed is:

1. A secure unit for secure storage, the secure unit having a communications interface for communicating with a control management system, wherein the secure unit receives an authorization access code from the control management system, the authorization access code being associated with an authorized time slot, the secure unit enabling access thereto responsive to use of the authorization access code in the authorized time slot at a user interface.

2. The secure unit of claim 1 wherein the authorization access code comprises a plurality of access codes.

3. The secure unit of claim 1 wherein a part of the authorization code is formed from a code selected from the group consisting of:
a goods authorization code associated with goods for delivery, and
a carrier authorization code associated with a delivery agent.

4. The secure unit of claim 3 wherein access to the secure unit is enabled responsive to the goods authorization code and the carrier authorization code.

5. The secure unit of claim 1 wherein the user interface includes an interface selected from the group consisting of:
a keypad interface, wherein at least a part of the authorization access code is entered via the keypad interface, and
an other communications interface for communicating with a remote device, wherein at least a part of the authorization access code is entered via the remote device.

6. The secure unit of claim 5 wherein the remote device is a portable device that communicates with the other communications interface via a wireless link selected from the group consisting of:
a Bluetooth link, and
an infra-red link.

7. The secure unit of claim 1 wherein at least a part of the authorization access code is provided in an encoded form as a bar-code on an object selected from the group consisting of:
the secure unit, and
goods for delivery.

8. The secure unit of claim 7 further comprising a remote device including a bar-code reader for displaying the encoded form part of the authorization access code.

9. The secure unit of claim 1 wherein the communication interface is a wireless interface.

10. The secure unit of claim 1 wherein the authorized time slot includes a window selected from the group consisting of:
a time window, and
a date window.

11. The secure unit of claim 1 wherein the secure unit transmits an alarm signal to the control management system responsive to use of an unauthorized access code.

12. A method of controlling access to a secure unit, the secure unit having a communications interface for communicating with a control management system, the method, comprising:
receiving an authorization access code including an authorized time slot from the control management system; and
enabling access to the secure unit responsive to use of the authorization access code.

13. The method of claim 12 wherein the authorization access code comprises a plurality of access codes.

14. The method of claim 12 wherein part of the authorization access code is formed from a code selected from the group consisting of:
a goods authorization code, and
a carrier authorization code.

15. The method of claim 14 further comprising enabling access to the secure unit responsive to the goods authorization code and the carrier authorization code.

16. The method of claim 12 further comprising entering the authorization access code via a user interface selected from the group consisting of:
a keypad interface, and
an other communications interface.

17. The method of claim 16 further comprising entering the authorization access code via a remote device having a communications link with the other communications interface wherein the communications link is selected from the group consisting of:
a wireless link,
a Bluetooth link, and
an infra-red link.

18. The method of claim 12 further comprising providing at least part of the authorization access code in encoded form as a bar-code on objects selected from the group consisting of:
the secure unit, and
goods for delivery.

19. The method of claim 18 further comprising providing a remote device including a bar-code reader for displaying the encoded form part of the authorization access code.

20. The method of claim 12 wherein the communications interface is a wireless interface.

21. The method of claim 12 further comprising providing the authorized time slot with a window selected from the group consisting of:
a time window, and
a date window.

22. The method of claim 12 further comprising transmitting an alarm signal to the delivery management system responsive to use of an unauthorized access code.

23. A secure unit for secure storage, the secure unit having a communications interface for communicating with a control management system, wherein the secure unit receives an authorization access code from the control management system, the authorization access code having at least two parts, the secure unit enabling access thereto responsive to use of the two parts of the authorization access code.

24. The secure unit of claim 23 wherein a part of the authorization code is formed from a code selected from the group consisting of:
a goods authorization code associated with the goods for delivery, and
a carrier authorization code associated with a delivery agent.

25. The secure unit of claim 23 wherein access to the secure unit is enabled responsive to the two parts of the authorization access code.

26. The secure unit of claim 23 wherein the user interface includes an interface selected from the group consisting of:
a keypad interface, wherein at least a part of the authorization access code is entered via the keypad interface, and
an other communications interface for communicating with a remote device, wherein at least a part of the authorization access code is entered via the remote device.

27. The secure unit of claim 26 wherein the remote device is a portable device that communicates with the other communications interface via a wireless link selected from the group consisting of:
a Bluetooth link, and
an infra-red link.

28. The secure unit of claim 23 wherein at least a part of the authorization access code is provided in encoded form as a bar-code on objects selected from the group consisting of:
the secure unit, and
goods for delivery.

29. The secure unit of claim 28 further comprising a remote device including a bar-code reader for displaying the encoded form part of the authorization access code.

30. The secure unit of claim 23 wherein the authorization access code is associated with an authorized time slot.

31. A method of controlling access to a secure unit, the secure unit having a communications interface for communicating with a control management system, the method compromising:
receiving an authorization access code including at least two parts from the control management system; and
enabling access to the secure unit responsive to use of the two parts of the authorization access code.

32. The method of claim 31 wherein part of the authorization access code is formed from a code selected from the group consisting of:
a goods authorization code, and
a carrier authorization code.

33. The method of claim 32 further comprising enabling access to the secure unit responsive to the goods authorization code and the carrier authorization code.

34. The method of claim 31 further comprising entering the authorization access code via a user interface selected from the group consisting of:
a keypad interface, and
an other communications interface.

35. The method of claim 36 further comprising entering at least part of the authorization access code via a remote device having a communications link with the other communications interface, wherein the communications link is a link selected from the group consisting of:
a wireless link,
a Bluetooth link, and
an infra-red link.

36. The method of claim 31 further comprising providing at least part of authorization access code in encoded form as a bar-code on an object selected from the group consisting of:
the secure unit, and
goods for delivery.

37. The method of claim 36 further comprising providing a remote device including a bar-code reader for displaying the encoded form part of the authorization access code.

38. The method of claim 31 wherein the authorization access code is associated with an authorized time slot.
